(19) United States
(12) Patent Application Publication
(10) Pub. No.: US 2012/0151398 A1
(43) Pub. Date: Jun. 14, 2012

(54) Image Tagging

(75) Inventors: Kevin O. Foy, Chicago, IL (US); David S. Brenner, Round Lake, IL (US); Roger Bye, Evanston, IL (US); Lucia Robles Noriega, Libertyville, IL (US)

(73) Assignee: Motorola Mobility, Inc., Libertyville, IL (US)

(21) Appl. No.: 12/964,269

(22) Filed: Dec. 9, 2010

(51) Int. Cl. G06F 3/048

(52) U.S. Cl. 715/769; 715/810

(57) ABSTRACT

Techniques (200) and apparatuses (100, 800) for image tagging are described. In some embodiments, an image-tagging module (114) is configured to enable selection of tags from different tag databases (116, 118) and to tag an image with a tag from one of the different tag databases (116, 118).

### BACKGROUND

Current computing applications permit users to organize images with folders. Organizing images with folders can be quite limiting, however, as images often are not so easily compartmentalized. An image can be placed in various different folders based on the date it was taken, the event at which it was taken, people or objects in the image, the image's topic, or some other descriptor. Not surprisingly, deciding into which folder to put an image can be confusing and time-consuming for users. Further, finding the image later can be difficult, as the user may look for the image in the wrong folder, such as by looking in a folder based on a date that the image was taken when the image is actually stored in a folder based on the people in the image.

Other current computing applications enable users to organize images with tags. Organizing images with tags addresses some of the limitations inherent in using folders. A user may tag an image with keywords, such as the date the image was taken, the event at which it was taken, and people in the image. To find the image later, the user need only remember one of the keywords, such as the date, the event, or one of the people in the image. These image-tagging computing applications, however, are often cumbersome to use, making assigning and managing tags difficult or time-consuming

### BRIEF DESCRIPTION OF THE DRAWINGS

Techniques and apparatuses for image tagging are described with reference to the following drawings. The same numbers are used throughout the drawings to reference like features and components:

FIG. 1 illustrates an example environment in which techniques for image tagging can be implemented.

FIG. 2 illustrates example method(s) for image tagging.

FIG. 3 illustrates an image and a user interface having selectable labels associated with different tag databases.

FIG. 4 illustrates the image of FIG. 3 along with a tag-selection/creation field.

FIG. 5 illustrates the image of FIG. 3 along with a thumbnail image, which a user may select to tag the image.

FIG. 6 illustrates the image of FIG. 3 along with keyword tag-selection fields.

FIG. 7 illustrates the image of FIG. 3 and four selected tags for the image.

FIG. 8 illustrates various components of an example apparatus that can implement techniques for image tagging.

### DETAILED DESCRIPTION

Current techniques for image tagging are often cumbersome, making assigning and managing tags difficult or time-consuming This disclosure describes techniques and apparatuses for image tagging using tags from at least two different databases, tables, or table columns, which often permits users to more-easily or more-quickly tag their images.

The following discussion first describes an operating environment, followed by image-tagging techniques that may be employed in this environment, and proceeding with example user interfaces and apparatuses.

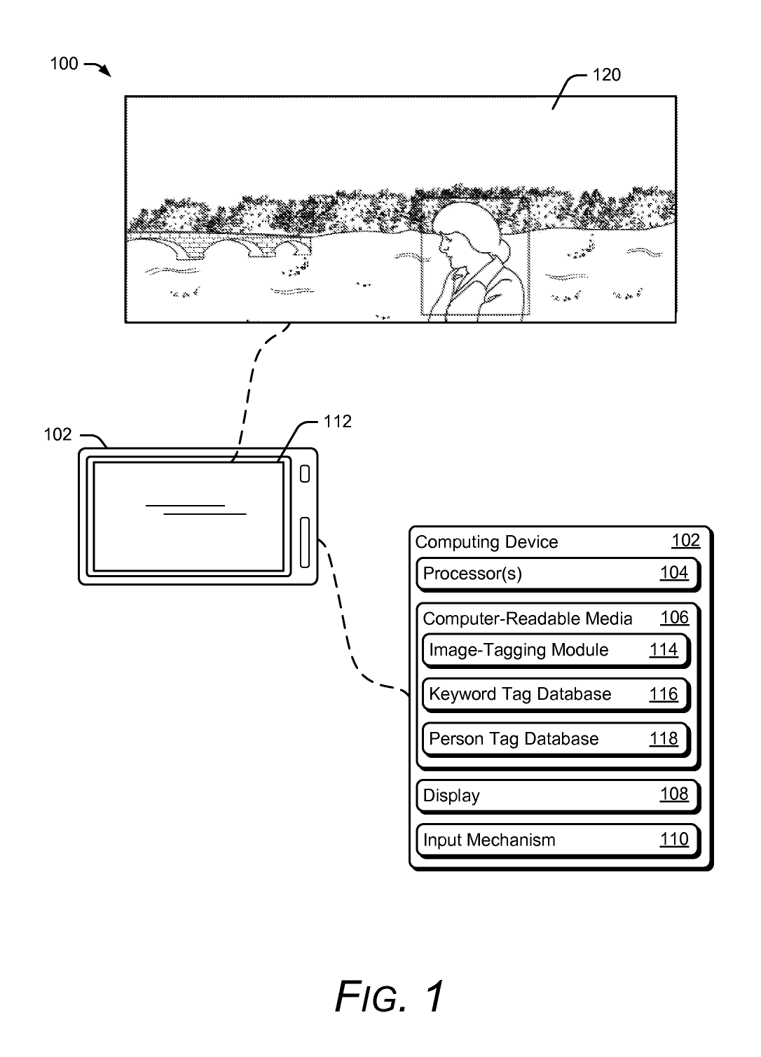

FIG. 1 illustrates an example environment 100 in which techniques for image tagging can be implemented. Example environment 100 includes a computing device 102 having one or more processors 104, computer-readable media 106, a display 108, and an input mechanism 110.

Computing device 102 is shown as a smart phone having an integrated touch-screen 112 acting as both display 108 and input mechanism 110. Various types of computing devices, displays, and input mechanisms may be used, however, such as a personal computer having a monitor and keyboard and mouse, a laptop with an integrated display and keyboard with touchpad, a cellular phone with a small integrated display and a telephone keypad plus navigation keys, or a tablet computer with an integrated touch screen.

Computer-readable media 106 includes an image-tagging module 114, a keyword tag database 116, and a person tag database 118. Image-tagging module 114 enables a user to tag an image using the computing device 102. To do so, image-tagging module 114 uses two or more tag databases having different tags. In the field of medical images, for example, one tag database could include cancer-based differential diagnoses and the other non-cancer-based differential diagnoses. In the field of artistic images, one tag database may include other works of art with which to tag an artistic image (e.g., names or images of the Mona Lisa and the Lindisfarne Gospels), and the other tag database may include descriptive classifications (e.g., still life, botanical, allegory, portrait, and landscape). Thus, these different tag databases include different tags. Note, however, that tag databases 116 and 118 may each reside on separate media, portions of media, or a same media. In one embodiment, for example, these tag databases 116 and 118 reside on a single media but on different tables in that media or on a same table but in different columns or rows in that same table.

In environment 100, the two databases used by image-tagging module 114 are keyword tag database 116 and person tag database 118. Keyword tag database 116 includes one or more keyword-based tags, such as textual descriptors like “summer,” “bridge,” “daydreaming,” “vacation,” “puppies,” “bridge,” “sunset,” and “flowers” to name just a few. Person tag database 118 includes tags associated with individuals or groups of humans, non-human entities, and role-based descriptors. Groups of humans may include the user's family as a whole, the user's classmates as a whole, or other groupings like the user's best friends or work colleagues, to name a few. Non-human entities can include a corporation or association, for example. Role-based descriptors describe or name a role occupied by a human or entity rather than a particular entity or human in the role, such as “the helpdesk,” “the vice president's secretary,” and the like.

Person tag database 118 can include, or have access to, a contact list associated with a user of computing device 102, e.g., persons that recently called, a formal contact list having information and thumbnail images of persons, a contact list drawing from a social-networking or business-networking website, and others.

Note that these different databases, keyword tag database 116 and person tag database 118, can be mutually exclusive but may have tags that appear similar in some fashion. Keyword tag database 116, for example, includes the textual descriptor “summer.” Person tag database 118 may include a tag associated with a person, “Summer Jones.” In such a case the “summer” textual tag and the “Summer” person tag may appear to a user to be the same tag, though they are actually different tags—one is associated with a person and the other with a description, among other differences. Other examples are readily apparent, such as other tags that can be descriptors or names of persons or places and things (e.g., May, June, Montana, River/river, and Stone/stone). In some cases these different tag databases 116, 118 are mutually exclusive, this exclusivity based on subject matter of the respective databases. Thus, in the above example, even though databases 116, 118 both include the term “summer” or “SUMMER”, the tags in each are different and mutually exclusive—even if they are spelled and capitalized exactly the same. At other times, the different tags can be differentiated by capitalization, icon or symbol, text color, background color, font, or other artifact.

Environment 100 also illustrates an example image 120 to which a tag may be associated by image-tagging module 114. As illustrated, this image includes a woman, river, and bridge. Image 120 will be used to illustrate various techniques described below.

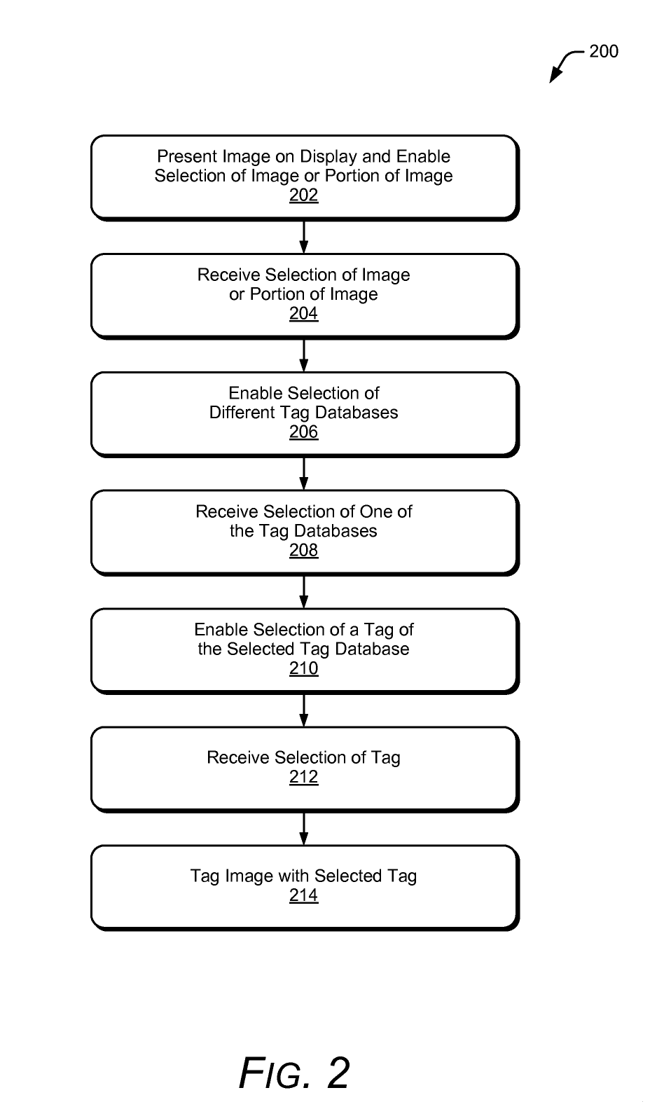

FIG. 2 illustrates example method(s) 200 for image tagging. The order in which the method blocks are described is not intended to be construed as a limitation, and any number or combination of the described method blocks can be combined in any order to implement a method, or an alternate method.

At block 202, an image is presented on a display and selection of the image or portion of the image is enabled. As noted above, various types of displays and ways in which to select an image on a display may be used. For example, image-tagging module 114, when operating on a desktop computing device having a monitor, keyboard, and mouse, displays an image on the monitor and enables selection of the image or portion thereof using the keyboard (e.g., arrows or coordinates) or the mouse (e.g., a cursor input).

In environment 100, computing device 102 renders image 120 and enables selection of a portion thereof on touch-screen 112, such as through a stylus or fingertip. In one case, image-tagging module 114 enables selection of a portion of the image by pressing and holding a fingertip on the portion of the image, though other gestures may be used.

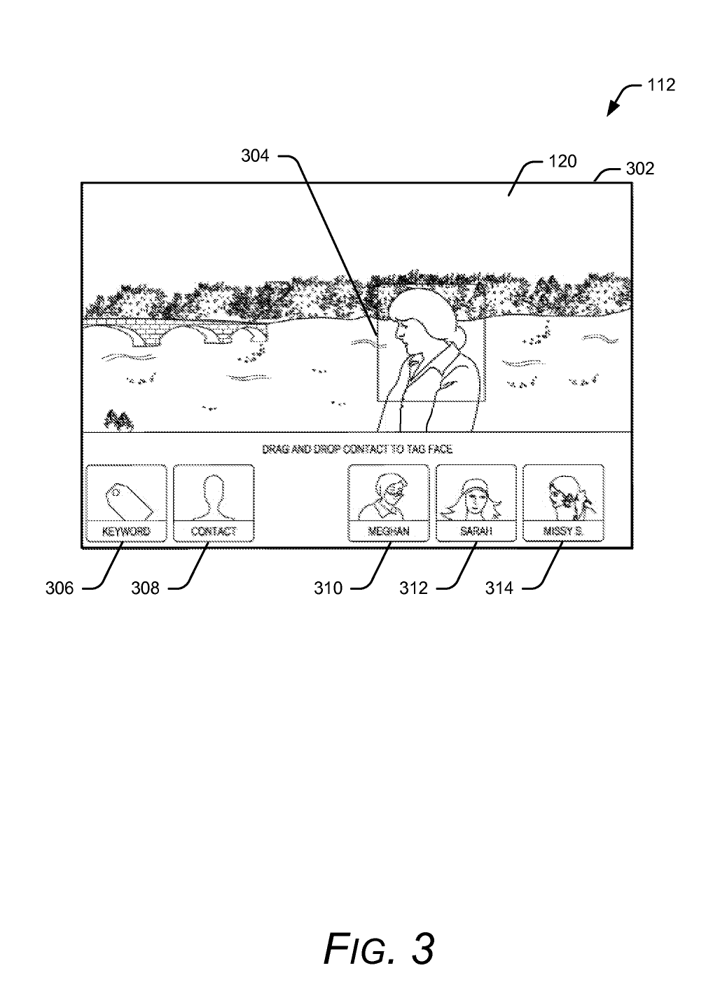

At block 204, selection of the image or portion thereof is received. Continuing the above example, assume that a user selected a portion of the image with his or her fingertip. One possible response of image-tagging module 114 is illustrated in FIG. 3.

FIG. 3 illustrates image 120 displayed with user interface 302 on touch-screen 112. User interface 302, which is generated by image-tagging module 114, provides an adjustable box 304 responsive to a user selecting a point in the image. User interface 302 permits the user to expand or contract adjustable box 304 in one or both axes. The size and location of adjustable box 304 can be saved for later use.

Blocks 202 and 204 are optional to method(s) 200, as is their order in method(s) 200. For example, image-tagging module 114 may employ object-recognition or face-recognition techniques on an image, thereby pre-selecting portions of the image to which to associate a selected tag. Further, block 202 and/or 204 can be performed after selection of the tag at block 212.

At block 206, selection of different tag databases is enabled. Image-tagging module 114 may enable selection in various ways, such as those described for selecting an image or portion of an image noted above, as well as others.

In the ongoing embodiment, image-tagging module 114 presents selectable labels for each of keyword tag database 116 and person tag database 118 at respective locations on touch-screen 112. User interface 302 of FIG. 3 includes keyword label 306 associated with keyword tag database 116 and person label 308 associated with person tag database 118.

The user is enabled to select one of these databases by pressing on its associated label. The user may also drag-and-drop a label from a starting location to a drop location on an image or portion thereof. Dropping a label may associate a later-selected tag with a particular image (if multiple images are selectable) or portion of an image, such as to associate a later-selected keyword from keyword tag database 116 with a portion of image 120 showing a bridge. Likewise, the user may drag-and-drop person label 308 over the face in image 120 to associate a later-selected tag from person tag database 118 with the face in the image. Note that dragging and dropping a label onto a portion of an image may select an association between that portion and a later selected tag or cause image-tagging module 114 to present further options, such as adjustable box 304.

At block 208, selection of one of the tag databases is received. As noted above, selection can be received in various manners. In the ongoing embodiment, however, selection is received via a press and hold or a drag-and-drop of a label associated with the respective tag database. Multiple scenarios are described below based on the tag database chosen, information about tags in the tag database, and ways in which tags are selected.

At block 210, selection of the tag of the selected tag database is enabled. Enabling selection of the tag of the selected tag database can be done in various manners, such as through lists presented with textual descriptors, thumbnail images, or labels (e.g., icons, names). Enabling selection can also be through a pop-up data entry field capable of receiving a text-based search responsive to which various keyword tags are made selectable. Further still, a user may create a new tag through this data-entry field after which the new tag can be tagged to the image.

By way of example, consider the two artistic tag databases described above. In the works-of-art tag database, thumbnail images for works of art can be presented. In the descriptive-classifiers tag database, a classification can be presented and, when selected, sub-classifications can further be presented by image-tagging module 114, such as presenting selectable subclasses of “Romanesque,” “Medieval,” and “modern” responsive to selection of “architecture.”

Returning to the ongoing embodiment, assume, for a first scenario, that image-tagging module 114 receives selection through a drag-and-drop of person label 308 onto adjustable box 304 to select the tag database. In response, image-tagging module 114 presents thumbnail images of persons having associated tags in person tag database 118. Three such thumbnail images are shown in FIG. 3 at 310, 312, and 314. Note that other scenarios are also contemplated herein, including permitting entry of a new person tag on selection of person label 308 over adjustable box 304. Entry of new tags is described later below.

As shown, image-tagging module 114 can determine tags from which to enable selection. Image-tagging module 114 can display thumbnail images associated with persons in a contact list that were most-recently used to tag images, most-often used to tag images, alphabetically, or based on a probability that a face recognized in image 120 matches a person having a tag in tag database 118, to name a few. In the ongoing embodiment, thumbnail images 310, 312, and 314 are provided based on being the three persons most-often or most-recently used to tag images.

As FIG. 3 illustrates, thumbnail images 310, 312, and 314 do not match the selected face in image 120 within adjustable box 304. In such a case, image-tagging module 114 enables selection, or creation, of a tag for the tag database. In this case image-tagging module 114 opens a search box in response to user selection or in response to the user failing to select one of thumbnail images 310, 312, and 314 within a certain amount of time.

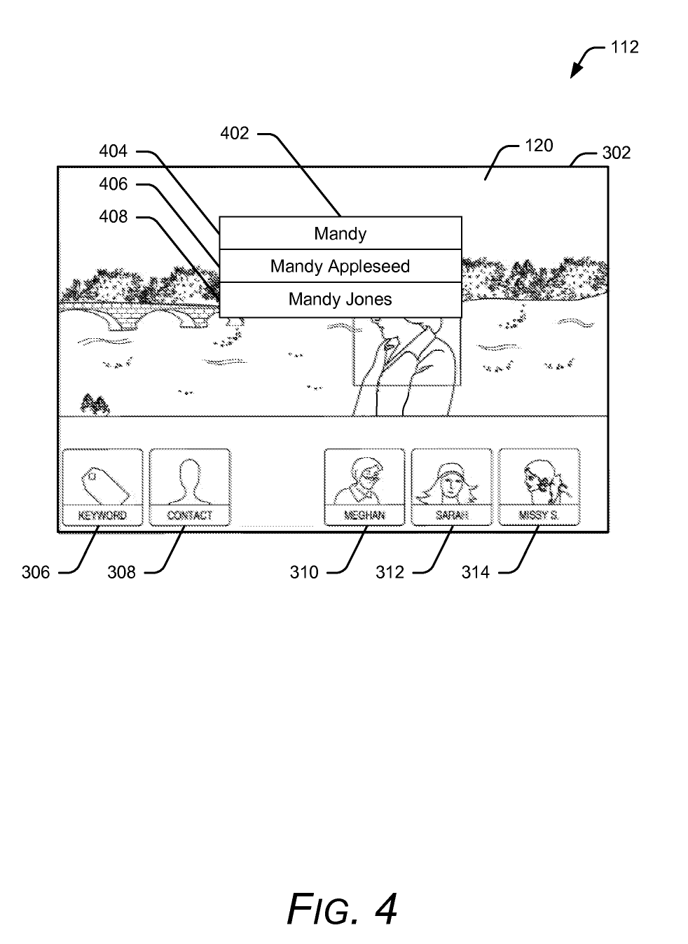

FIG. 4 illustrates tag-selection/creation field 402. Here image-tagging module 114 presents a pop-up data entry field 404 into which a user may enter text, in response to which existing tags are listed or a new tag is created. In this case, the user enters “Mandy” at field 404, in response to which image-tagging module 114 presents two existing tags, “Mandy Appleseed” and “Mandy Jones” at selectable tag fields 406 and 408, respectively.

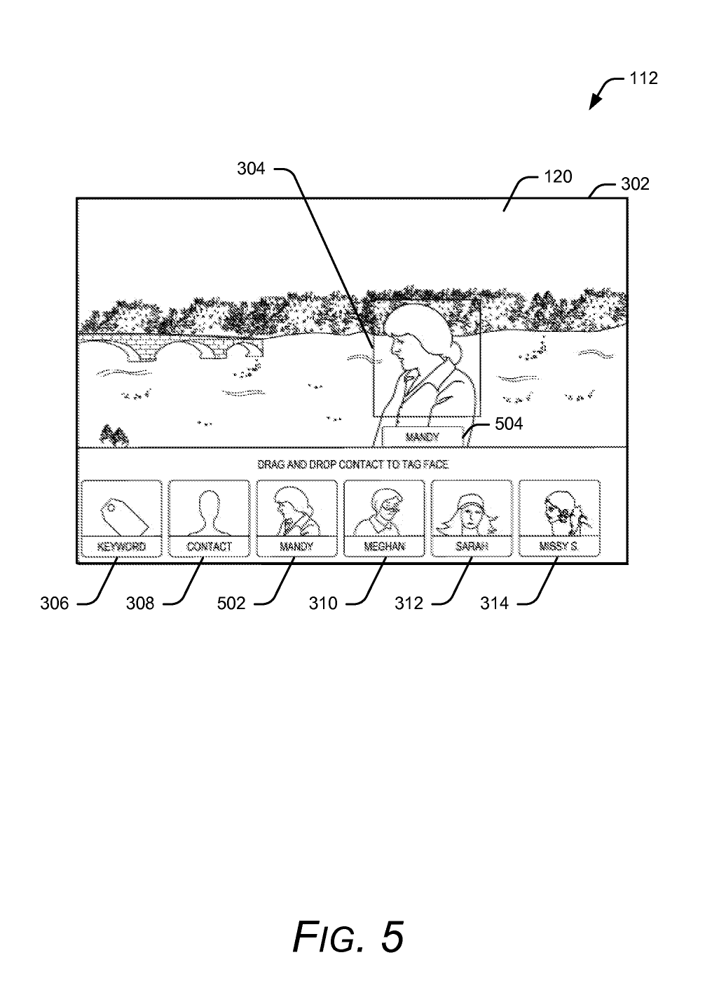

Completing the first scenario, consider FIG. 5, which illustrates thumbnail image 502, which the user may select to tag image 120 with the tag associated with “Mandy Appleseed.” Image-tagging module 114 may treat selection or creation of the “Mandy Appleseed” tag as a selection to tag image 120. Alternatively, image-tagging module 114 may wait for selection of thumbnail image 502.

Note that for the first scenario image-tagging module 114 did not at first present a desired, selectable tag. Image-tagging module 114, however, enabled selection of the desired tag with further user interaction.

In many cases, however, image-tagging module 114 enables selection of a tag that is desired by the user immediately on selection of the tag database. An example of such a case includes enabling selection of thumbnail image 502 in direct response to receiving a drag-and-drop of contact label 308 on image 120. In a second scenario, image-tagging module 114 presents thumbnail image 502 based on it being a likely match to the face shown in adjustable box 304 or the person associated with the tag and thumbnail image (“Mandy Appleseed”) being a recently or often-used tag. Thus, image-tagging module 114 in this second scenario does not receive or need user interaction to present a selectable tag.

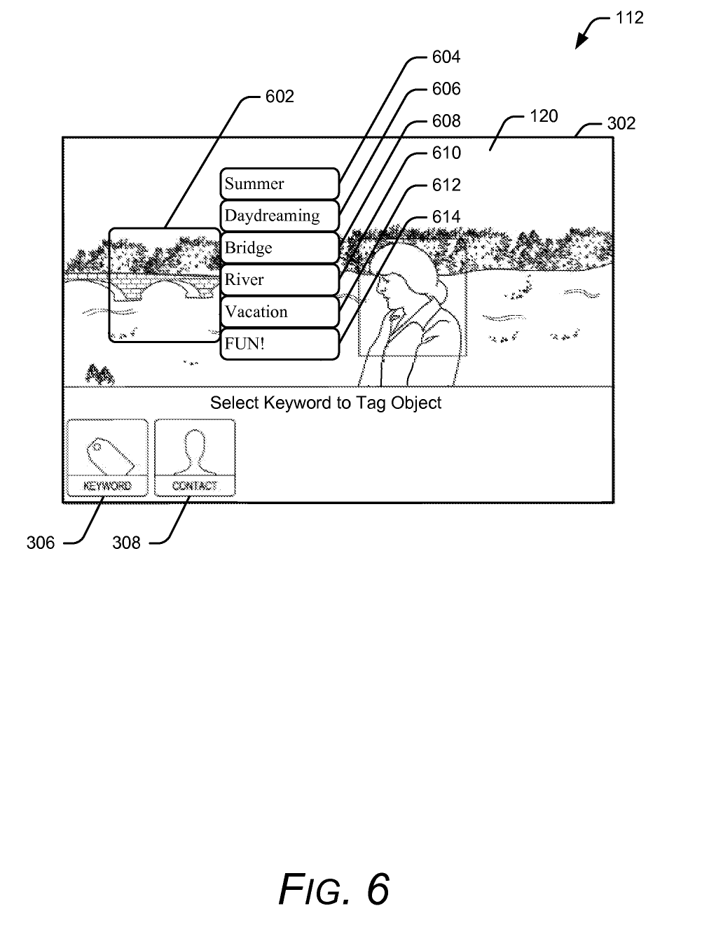

Before continuing to block 212, consider a third scenario for enabling selection of tags. Assume for this scenario that image-tagging module 114 receives selection of keyword tag database 116 through a drag-and-drop of keyword label 306 shown in FIG. 6. In response to this selection, image-tagging module 114 presents selectable tags through user interface 302. Here the bridge shown in image 120 at object box 602 is assumed to be previously selected by the user or by image-tagging module 114 through object-recognition techniques.

Image-tagging module 114 presents selectable tags at keyword tag-selection fields 604, 606, 608, 610, 612, and 614. If one of the presented selectable tags is not selected, image-tagging module 114 presents a data entry field or other manner in which to enable a user to search for, or create, other keyword tags.

At block 212, selection of a tag is received. Concluding the third scenario, assume that image-tagging module 114 receives selection of a keyword tag named “Bridge” for the bridge shown in image 120 at object box 602. Note that this keyword tag can be associated with image 120 and also with the portion or object of image 120 at object box 602. Combining some of the examples noted above, assume that image-tagging module 114 also receives selection of the “Mandy Appleseed” tag and both keyword tags “Summer” and “Daydreaming” for image 120 generally. Thus, four tags have been selected, two tags associated with particular portions of image 120, namely “Mandy Appleseed” and “Bridge,” and two tags associated with image 120 generally, “Summer” and “Daydreaming.”

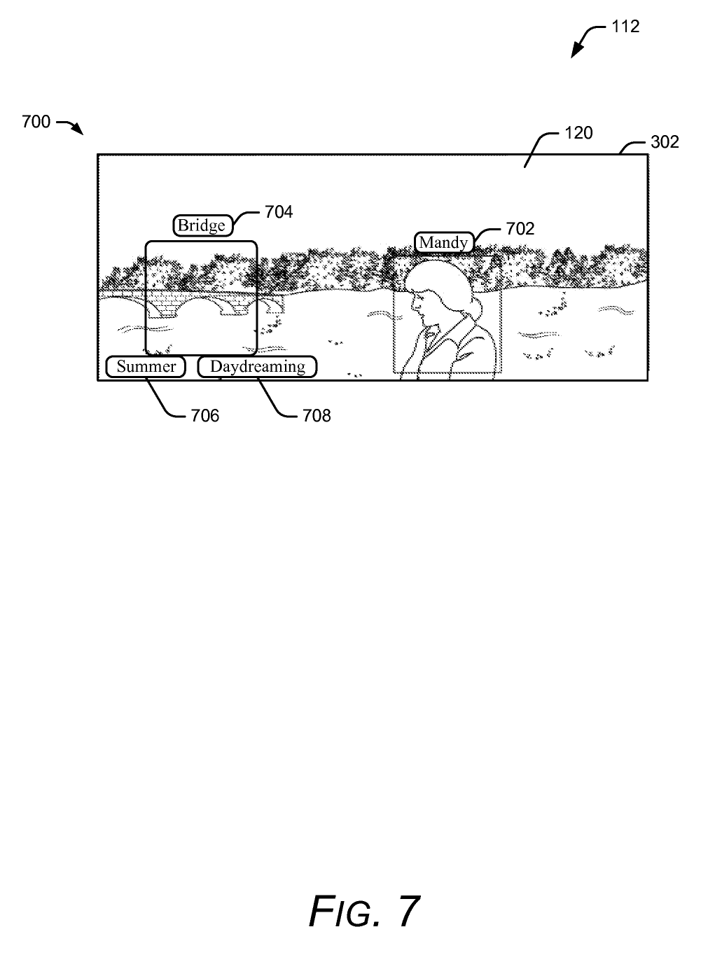

At block 214, the image is tagged with the selected tag. Continuing this ongoing embodiment, consider FIG. 7, which illustrates image 120 and shows, in user interface 302, all four selected tags. Image-tagging module 114 shows these tags labeled “Mandy” 702, “Bridge” 704, “Summer” 706, and “Daydreaming” 708. In this implementation, a tag from the contact database includes a person icon while a tag from the keyword database does not have any icon. It is also possible to include an icon (e.g., a “label” icon) on the tags from the keyword database, or no icons for any keywords.

Image-tagging module 114 enables a user to continue to other tasks, such as tagging other images, or completing this tagging session. At some later point, image-tagging module 114 enables a user to search for images based on tags. In this case, image-tagging module 114 will find image 120 if any one of these four selected tags is used in the search.

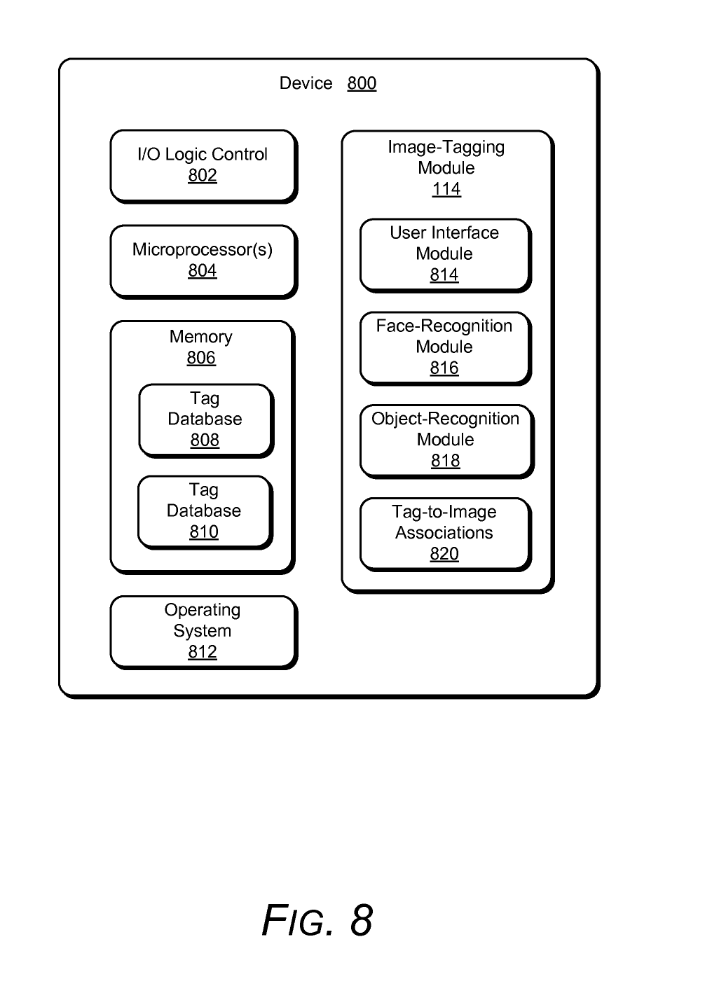

FIG. 8 illustrates various components of an example device 800 including image-tagging module 114 including or having access to other modules, these components implemented in hardware, firmware, and/or software and as described with reference to any of the previous FIGS. 1-7.

Example device 800 can be implemented in a fixed or mobile device being one or a combination of a media device, computing device (e.g., computing device 102 of FIG. 1), television set-top box, video processing and/or rendering device, appliance device (e.g., a closed-and-sealed computing resource, such as some digital video recorders or global-positioning-satellite devices), gaming device, electronic device, vehicle, and/or workstation.

Example device 800 can be integrated with electronic circuitry, a microprocessor, memory, input-output (I/O) logic control, communication interfaces and components, other hardware, firmware, and/or software needed to run an entire device. Example device 800 can also include an integrated data bus (not shown) that couples the various components of the computing device for data communication between the components.

Example device 800 includes various components such as an input-output (I/O) logic control 802 (e.g., to include electronic circuitry) and microprocessor(s) 804 (e.g., microcontroller or digital signal processor). Example device 800 also includes a memory 806, which can be any type of random access memory (RAM), a low-latency nonvolatile memory (e.g., flash memory), read only memory (ROM), and/or other suitable electronic data storage. Memory 806 includes or has access to different tag databases 808, 810. Examples of tag databases are set forth above.

Example device 800 can also include various firmware and/or software, such as an operating system 812, which can be computer-executable instructions maintained by memory 806 and executed by microprocessor 804. Example device 800 can also include other various communication interfaces and components, wireless LAN (WLAN) or wireless PAN (WPAN) components, other hardware, firmware, and/or software.

Example device 800 includes image-tagging module 114, which optionally includes or has access to other modules. These modules include a user interface module 814, a face-recognition module 816, and an object-recognition module 818. User interface module 814 is capable of providing a user interface through which a user may select tags from two or more databases, such as example user interface 302 set forth above. Face-recognition module 816 is capable of recognizing faces in an image and determining probabilities that a recognized face matches a face stored elsewhere, such as in one of databases 808 or 810. Object-recognition module 818 is capable of recognizing objects in an image, such as the river or bridge shown in image 120. Both recognition modules 816 and 818 can be used by image-tagging module 114 to select portions of an image and build probabilities that particular tags are appropriate to match with something recognized in an image. User interface module 814 may use information from recognition module 816 or 818 to highlight portions of interest in an image at appropriate locations and sizes, such as a starting size and location of adjustable box 304 of FIG. 3.

Image-tagging module 114 also includes tag-to-image associations 820, which can be used to store associations between tags and images, such as the four selected tags illustrated in FIG. 7.

Other examples capabilities and functions of these modules are described with reference to elements shown in FIG. 1 and illustrations of FIGS. 3-7. These modules, either independently or in combination with other modules or entities, can be implemented as computer-executable instructions maintained by memory 806 and executed by microprocessor 804 to implement various embodiments and/or features described herein. These modules may also be provided integral with other modules of device 800, such as integrated with image-tagging module 114. Alternatively or additionally, any or all of these modules and the other components can be implemented as hardware, firmware, fixed logic circuitry, or any combination thereof that is implemented in connection with the I/O logic control 802 and/or other signal processing and control circuits of example device 800. Furthermore, some of these modules may act separate from device 800, such as face-recognition module 816 and object-recognition module 818, which can be remote (e.g., cloud-based) modules performing services for image-tagging module 114.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method, comprising:
enabling selection of one tag database from different tag databases, each of the different tag databases including different tags;
receiving the selection of a selected tag database;
enabling selection of a tag from the selected tag database;
receiving the selection of a selected tag; and
tagging an image with the selected tag.

2. The method as recited in claim 1, wherein the different tags of the different tag databases are mutually exclusive based on different subject matter, respectively, of the different tag databases.

3. The method as recited in claim 1, wherein the different tag databases include a first tag database and a second tag database, the first tag database including person-based tags and the second tag database including non-person-based tags.

4. The method as recited in claim 3, wherein the first tag database includes a contact list and each of the person-based tags of the first tag database is associated with a person listed in the contact list.

5. The method as recited in claim 4, wherein enabling selection of a tag comprises:
displaying at least one thumbnail image associated with one of the person-based tags.

6. The method as recited in claim 5, wherein the at least one thumbnail image is associated with a person-based tag most-frequently or most-recently tagged to one or more other images.

7. The method as recited in claim 5, wherein said receiving the selection of a selected tag includes receiving a selection of one of the at least one thumbnail images and the method further comprising:
determining that a portion of the image represents a person associated with the selected thumbnail image; and
wherein the tagging an image with the selected tag comprises:
associating the selected tag with the determined portion of the image.

8. The method as recited in claim 4, wherein the person-based tags are associated with one or more of human individuals, human groups, non-human entities, or descriptors of a person's role.

9. The method as recited in claim 1, wherein the different tag databases are enabled for selection by displaying different selectable labels that each correspond to a respective tag database, and wherein the receiving the selection of a selected tag database includes receiving a label selection of the selectable label that corresponds to the selected tag database.

10. The method as recited in claim 9, wherein the receiving the selection of the selected tag database is a drag-and-drop selection, and wherein said receiving the label selection includes a drag-and-drop selection of the selectable label from a starting location on a display to a drop location on the display.

11. The method as recited in claim 10, wherein the drop location includes a selected portion of the image, and the selected tag is associated with the selected portion of the image.

12. The method as recited in claim 1, further comprising:
displaying the image on a display;
enabling selection of a portion of the image on the display;
receiving a selection of the portion of the image; and
associating the selected tag with the selected portion of the image.

13. The method as recited in claim 1, further comprising:
generating a new tag that is not included in the selected tag database, and wherein:
enabling selection of a tag from the selected tag database enables selection of the new tag; and
receiving the selection of a selected tag receives selection of the new tag.

14. The method as recited in claim 1, further comprising:
displaying at least one keyword associated with a tag in the selected tag database.

15. The method as recited in claim 1, further comprising:
displaying a pop-up data entry field to display received text; and
responsive to receiving the text, determining a tag that is associated with the received text.

16. A device, comprising:
a memory configured to maintain different tag databases that each include mutually exclusive tags;
a display configured to display an image; and
one or more processors to implement an image-tagging module configured to:
receive a database selection of one of the tag databases;
receive a tag selection of a tag in the selected tag database; and
tag the displayed image with the selected tag.

17. The device as recited in claim 16, wherein the image-tagging module is further configured to recognize a face in a portion of the displayed image and tag the portion of the displayed image that includes the recognized face with the selected tag.

18. The device as recited in claim 16, wherein the image-tagging module is further configured to recognize an object in a portion of the displayed image and tag the portion of the displayed image that includes the recognized object with the selected tag.

19. The device as recited in claim 16, wherein the image-tagging module is further configured to generate a new tag that is not included in the selected tag database, and tag the displayed image with the new tag.

20. The device as recited in claim 16, wherein the selected tag database includes person-based image tags and includes a contact list, and wherein each of the person-based image tags is associated with a person listed in the contact list, the person listed in the contact list being a human individual, group of humans, non-human entity, or role-based descriptor.
